(19) United States
(12) Patent Application Publication
(10) Pub. No.: US 2002/0092892 A1
(43) Pub. Date: Jul. 18, 2002

(54) Wire bonding method

(75) Inventor: Kai-Kuang Ho, Feng-Shan City (TW)

Correspondence Address: Daniel R. McClure, THOMAS, KAYDEN, HORSTEMEYER & RISLEY, L.L.P., Suite 1750, 100 Galleria Parkway N.W., Atlanta, GA, 30339, US

(73) Assignee: United Microelectronics Corp., Hsinchu (TW)

(21) Appl. No.: 09/759,445

(22) Filed: Jan. 12, 2001

(51) Int. Cl. B23K 31/02

(52) U.S. Cl. 228/180.5; 228/4.5

(57) ABSTRACT

A wire bonding method. A chip having an active surface and a corresponding back surface is provided, wherein the chip has a plurality of bonding pads, each of which is located in the center of the active surface. A printed circuit board having a plurality of contact points, each of which corresponds to one of the bonding pads, is provided. A bonding material is provided to attach the back surface of the chip to the printed circuit board. A conductive bump is formed on each of the bonding pads. First bonds are formed respectively on the contact points by a wire bonder using metal wires. The metal wires are pulled respectively to the conductive bumps on the corresponding bonding pads.

### BACKGROUND OF THE INVENTION

1. Field of the invention

The present invention relates to a wire bonding method. More specifically, the present invention relates to a wire bonding method useful for a chip on board (COB), especially for a DRAM chip on the printed circuit board (PCB).

2. Description of the related art

In integrated circuit products with a low amount of pins, a common method is to electrically connect the bonding pads on the chip to the leads on the lead frame by wire bonding. This kind of product includes small outline package (SOP), quad flat package (QFP) etc. There are two different types of bonding pad arrangements on the chip: a periphery pad arrangement and a central pad arrangement.

For a DRAM chip that requires less pins and has a simple inner circuit, the bonding pads can be arranged in the center of the chip to share part of the leads. Therefore, a package process of lead on chip (LOC) is usually used. After the packaging of the DRAM chip is finished, the packaged DRAM chip is mounted to the printed circuit board by surface mount technology (SMT). In order to simplify the process, a technology of attaching the chip to the module printed circuit board (COB) by wire bonding is further proposed before molding.

In the prior art, when the DRAM chip is attached to the module printed circuit board by wire bonding, a first bond is formed on a bonding pad by a wire bonder using metal wires. The metal wire is extended to a predetermined distance from the first bond, then pulled down to a gold finger and stitched. Since the bonding pads are arranged in the center of the DRAM chip, the distance from the bonding pad to the PCB is greater than the distance when the bonding pads are arranged in the periphery of the DRAM chip. Furthermore, the wire used for wire bonding the central pad type chip is pulled upward and then toward the gold finger on the printed circuit board. Thus, a wire short often occurs at the edge of the chip when the height of the pull-up wire is not enough for crossing over the edge of the chip, resulting in a reduced yield.

In view of the foregoing, the main disadvantage in the prior technology of attaching the DRAM chip to the module printed circuit board is that a wire short often occurs at the edge of the chip, resulting in a reduced yield.

FIG. 1 is a schematic view of a conventional DRAM module. FIG. 2 is a schematic, enlarged view of a local region 100 of FIG. 1. As shown in FIG. 1, a plurality of DRAM devices 102 are provided on the module print circuit board 104. For ease of illustration, FIG. 2 does not show the molding compound of the DRAM device 102 and only shows a chip 108 of a DRAM device. The bonding pads 106 are located in the center of the chip 108 and are electrically connected to gold finger 112, which is at both sides of the chip 108 on the module print circuit board 104, by using metal wires 110 such as gold wires.

FIG. 3 is a local cross sectional view of FIG. 1. In FIG. 3, the chip 108 has an active surface 108a and a corresponding back surface 108b. The active surface 108a has bonding pads 106 located at the center thereof. The back surface 108b of the chip 108 is attached on the module print circuit board 104 with a tape 122. A first bond 116 is formed on the bonding pad 106 by a wire bonder (not shown). The bonding pad 106 on the active surface 108a of the chip 108 is electrically connected to the gold finger 112 on the module printed circuit board 104. The chip 108, the gold wire 110, the gold finger 112 and part of the module printed circuit board 104 are encapsulated with a molding compound 114. Therefore, the chip 108 can be mounted on the module printed circuit board 104.

FIG. 4 is a schematic view of a first bond for a conventional DRAM chip. FIG. 5 is a schematic view of a second bond for a conventional DRAM chip. Referring to FIG. 4, if the DRAM chip 108 is attached to a module PCB 104 by a conventional wire bonding method, a first bond 116 is first formed on a bonding pad located on the active surface 108a of the chip 108 by wire bonding head 126 of a wire bonder (shown in part) using the metal material filled in the wire binding tube 124. Referring to FIG. 5, which follows from FIG. 4, the wire is pulled up from the first bond on the bonding pad 106 and extended to a predetermined distance. Then, the wire is pulled down to the gold finger 112 of the module PCB 104 and stitched. At this time, since the bonding pads 106 on the DRAM chip 108 are arranged in the center of the chip, the wire needed is longer than the wire needed for the peripheral pads. The wire pulled up form the bonding pad 106 and then down to the gold finger 112 is often short to the chip edge, resulting in a reduced yield.

### SUMMARY OF THE INVENTION

In order to overcome the prior problems, a wire bonding method is provided, comprising the following steps. A chip having an active surface and a corresponding back surface is provided, wherein the chip has a plurality of bonding pads, each of which is located in the center of the active surface. A printed circuit board having a plurality of contact points, each of which corresponds to one of the bonding pads, is provided. A bonding material is provided to attach the back surface of the chip to the printed circuit board. A conductive bump is formed on each of the bonding pads. First bonds are formed respectively on the contact points by a wire bonder using metal wires. The metal wires are pulled respectively to the conductive bumps on the corresponding bonding pads.

A packaging method also is provided, comprising the following steps. A chip having an active surface and a corresponding back surface is provided, wherein the chip has a plurality of bonding pads, each of which is located in the center of the active surface. A printed circuit board having a plurality of contact points, each of which corresponds to one of the bonding pads is provided. A bonding material is provided to attach the back surface of the chip to the printed circuit board. A conductive bump is formed on each of the bonding pads. First bonds are formed respectively on the contact points by a wire bonder using metal wires. The metal wires are pulled respectively to the conductive bumps on the corresponding bonding pads. The chip, the metal wires, the contact points and part of the printed circuit board are encapsulated with an insulating material.

In one aspect of the present invention, the metal wire is coupled to the contact point on the PCB, then pulled down to the corresponding bonding pad from the contact point. This can avoid the problems in the prior art that the metal wire is extended outward and then pulled down to the contact point on the PCB, causing a wire short at the edge of the DRAM chip.

In another aspect of the present invention, forming a conductive bump on the bonding pad can be performed by a wire bonder.

### BRIEF DESCRIPTION OF THE DRAWINGS

It is to be understood that both the foregoing general description and the following detailed description are exemplary, and are intended to provide further explanation of the invention as claimed.

The accompanying drawings are included to provide a further understanding of the invention, and are incorporated in and constitute a part of this specification. The drawings illustrate embodiments of the invention and, together with the description, serve to explain the principle of the invention. In the drawings,

FIG. 1 is a schematic view of a conventional DRAM module;

FIG. 2 is a schematic, enlarged view of a local region 100 of FIG. 1;

FIG. 3 is a local cross sectional view of FIG. 1;

FIG. 4 is a schematic view of a first bond for a conventional DRAM chip;

FIG. 5 is a schematic view of a second bond for a conventional DRAM chip;

FIG. 6 is a schematic view of DRAM module according to a preferred embodiment of the present invention;

FIG. 7 is a schematic, enlarged view of the local region 200 of FIG. 6;

FIG. 8 is a local cross sectional view of FIG. 6; and

FIG. 9 and FIG. 10 are drawings that illustrate the procedures of wire bonding a DRAM chip according to one preferred embodiment of the present invention.

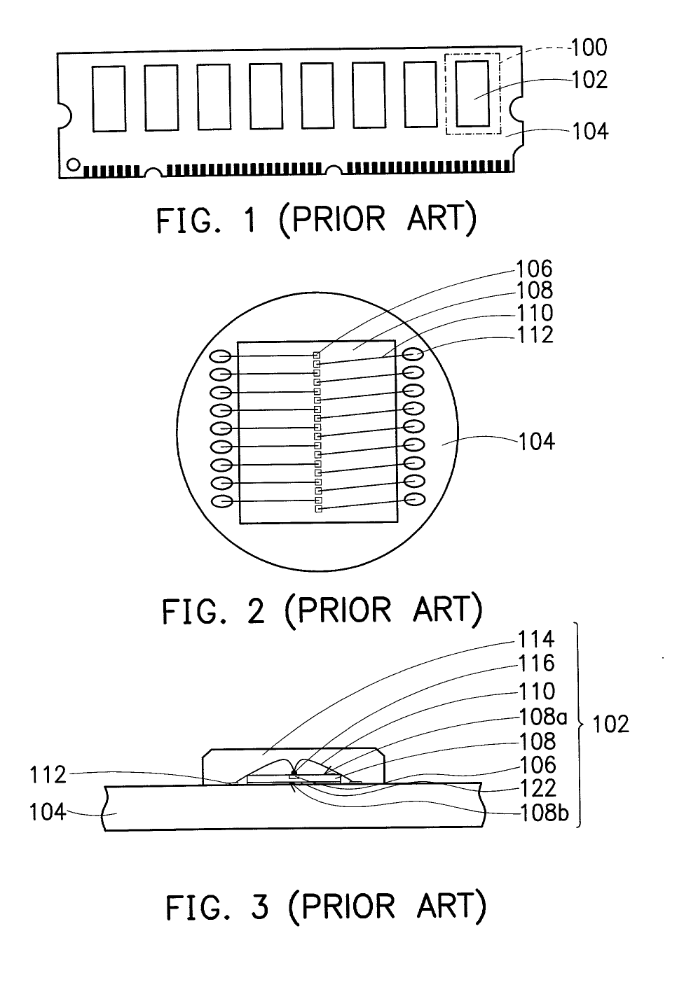

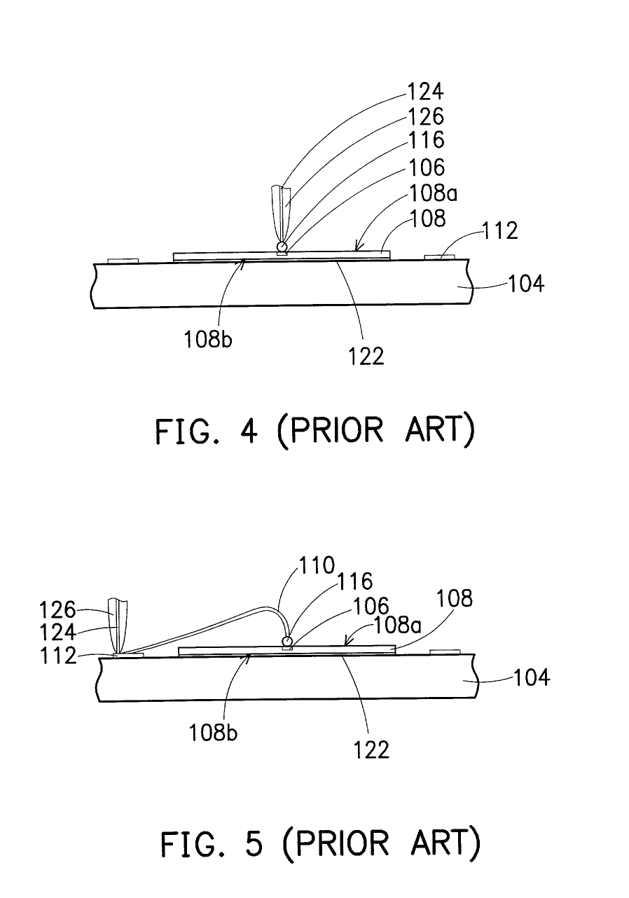

### DESCRIPTION OF THE PREFERRED EMBODIMENT

Reference will now be made in detail to the present preferred embodiments of the invention, examples of which are illustrated in the accompanying drawings. Whenever possible, the same reference numbers are used in the drawings and the description to refer to the same or like parts.

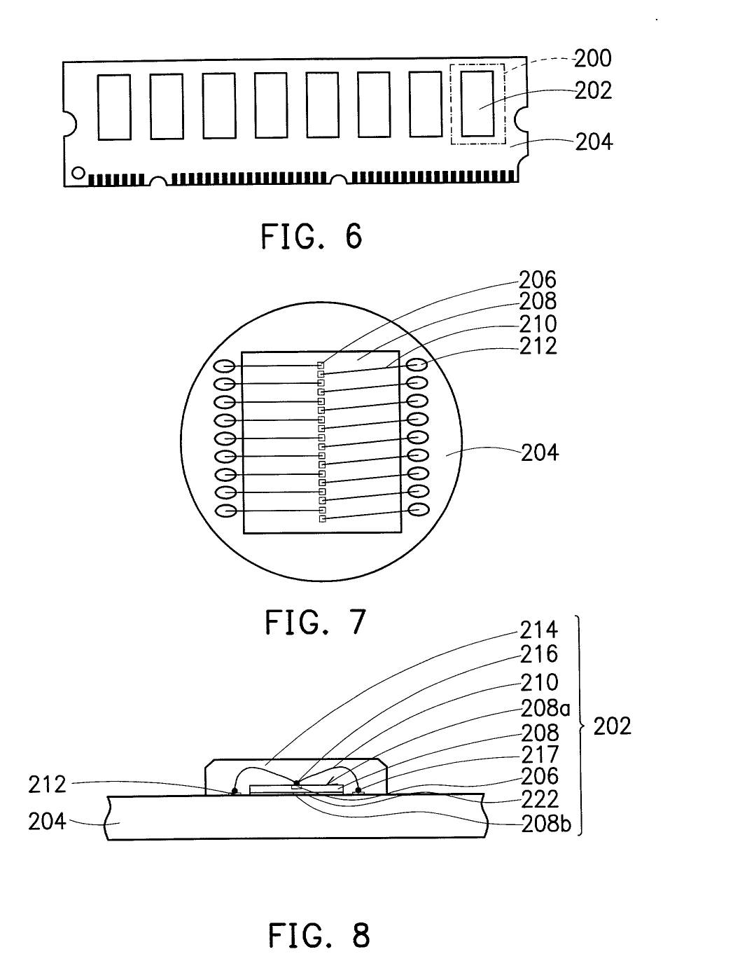

FIG. 6 is a schematic view of a DRAM module according to a preferred embodiment of the present invention. FIG. 7 is a schematic, enlarged view of the local region 200 of FIG. 6. As shown in FIG. 6, a plurality of DRAM devices 202 are provided on the module print circuit board 204. For ease of illustration, FIG. 7 does not show the molding compound of the DRAM device 202 and only shows a chip 208 of the DRAM device. The bonding pads 206 are located in the center of the chip 208 and are coupled to contact points 212, such as gold fingers at both sides of the chip 208 on the module print circuit board 204, by using metal wires 210 such as gold wires.

FIG. 8 is a local cross sectional view of FIG. 6. In FIG. 8, the chip 208 has an active surface 208a and a corresponding back surface 208b. The active surface 208a has bonding pads 206 located at the center thereof The back surface 208b of the chip 208 is attached on the module print circuit board 204 with a bonding material 222 such as tape. Electric bumps 216 and 217 are provided on the bonding pad 206 of the chip 208 and the contact point 212 of the module printed circuit board 204, respectively. The bonding pad 206 on the active surface of the chip 208 is electrically coupled to the contact point 212 on the module printed circuit board 204 by the wire bonder using metal wires 210. The chip 208, the gold wire 210, the contact point 212 and part of the module printed circuit board 204 are encapsulated with an insulating material such as a molding compound. Therefore, the chip 208 can be mounted directly on the module printed circuit board 204.

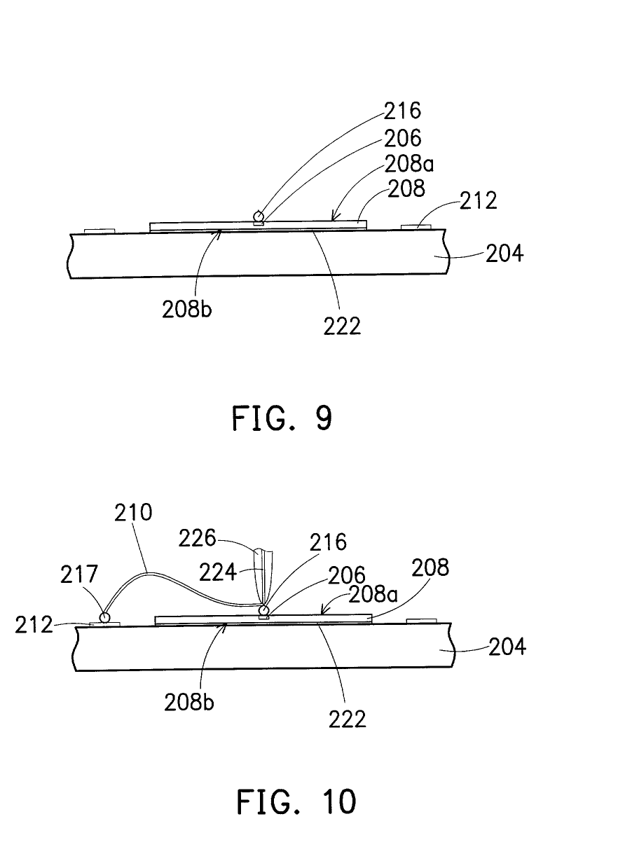

FIG. 9 and FIG. 10 illustrate the procedures of wire bonding a DRAM chip according to one preferred embodiment of the present invention. In FIG. 9, after the DRAM 208 is attached directly to the module printed circuit board 204 by the bonding method according to one preferred embodiment of the present invention, a conductive bump 216 is formed on the bonding pad 206, which is located on the active surface 208a of the chip 208. The conductive bump 216, such as a gold bump, is formed, for example, by a wire-bonding head 226 of a wire bonder (shown in part) using a metal material filled in the wire bonding tube 224. In FIG. 10, the first bond 217 is formed on the contact point 212 of the module printed circuit board 204 by the wire bonding head 226, after the conductive bump 216 as shown in FIG. 9 is formed. The wire extends upward from the first bond 217 on the contact point 212 to a predetermined distance and then downward to the conductive bump 216 on the bonding pad 206. Then, the wire is stitched and the wire bonding is finished.

In the semiconductor package method according to one preferred embodiment of the present invention, as shown in FIG. 8, after the wire bonding is completed, an insulating material 214 is used to encapsulate the chip 208, the metal wires 210, the contact point 212 and part of the printed circuit board 204.

Since the bonding pads 206 of the DRAM chip 208 are located in the center of the chip, the length of the wire for the central pad type wire bonding is longer than the length of the wire in a periphery pad type wire bonding. In the present invention, wire bonding includes forming a first bond 217 on the contact point 211 of the PCB 214 by metal wires, pulling the metal wire upward for a predetermined distance, and then toward the conductive bump 216 located on the bonding pad 206. The metal wire goes upward and crosses over the edge of the chip 208, then toward the conductive bump 216 on the bonding pad. Therefore, the wire short occurring at the edge of the die due to the excessively small distance from the chip to the wire in the wire bonding method of the prior art can be prevented.

In one aspect of the present invention, the metal wire 210 is attached to the contact point 212 on the PCB 204, then pulled up and then toward the corresponding bonding pad 206 from the contact point 212, with the metal wire crossing over the edge of the chip. This can avoid the problems in the prior art in which the metal wire is pulled up, outward and then toward the contact point on the PCB, causing a wire short at the edge of the DRAM chip when the height of the pull-up wire is not enough..

In another aspect of the present invention, forming a conductive bump 216 on the bonding pad 206 can be performed by a wire bonder.

According to the present invention, a central pad type chip, particularly a DRAM chip can be attached to the PCB, without problems such as a wire short occurring at the edge of the chip when wire bonding.

As shown above, the present invention provides at least the following advantages:

1. The wire bonding according to the present invention includes forming a first bond on the contact point of the PCB by the metal wire, extending the metal wire upward to a predetermined distance, and pulling the metal wire toward the conductive bump located on the bonding pad. Since the metal wire goes upward and crosses over the edge of the chip, then toward the conductive bump on the bonding pad, a wire short occurring at the edge of the die due to the excessively small distance from the chip to the wire in the wire bonding method of the prior art can be prevented.

2. A central pad type chip, particularly a DRAM chip can be attached to the PCB, without problems such as a wire short occurring at the edge of the chip when wire bonding.

It will be apparent to those skilled in the art that various modifications and variations can be made to the structure of the present invention without departing from the scope or spirit of the invention. In view of the forgoing, it is intended that the present invention cover modifications and variations of this invention provided they fall within the scope of the following claims and their equivalents.

What is claimed is:

1. A wire bonding method, comprising:
providing a chip having an active surface and a corresponding back surface, wherein the chip has a plurality of bonding pads each of which is located in the center of the active surface;
providing a printed circuit board having a plurality of contact points each of which corresponds to one of the bonding pads;
providing a bonding material to attach the back surface of the chip to the printed circuit board;
forming a conductive bump on each of the bonding pads;
forming first bonds respectively on the contact points by a wire bonder using metal wires; and
pulling the metal wires from the first bonds respectively to the conductive bumps on the corresponding bonding pads.

2. The wire bonding method of claim 1, wherein the bonding material is tape.

3. The wire bonding method of claim 1, wherein forming a conductive bump on each of the bonding pads is performed by the wire bonder.

4. The wire bonding method of claim 1, wherein the conductive bump is made of gold.

5. The wire bonding method of claim 1, wherein the material for the metal wire is gold.

6. A packaging method, comprising:
providing a chip having an active surface and a corresponding back surface, wherein the chip has a plurality of bonding pads each of which is located in the center of the active surface;
providing a printed circuit board having a plurality of contact points each of which corresponds to one of the bonding pads;
providing a bonding material to attach the back surface of the chip to the printed circuit board;
forming a conductive bump on each of the bonding pads;
forming first bonds respectively on the contact points by a wire bonder using metal wires;
pulling the metal wires from the first bonds respectively to the conductive bumps on the corresponding bonding pads; and
encapsulating the chip, the metal wires, the contact points and part of the printed circuit board with an insulating material.

7. The packaging method of claim 6, wherein the bonding material is tape.

8. The wire bonding method of claim 6, wherein forming a conductive bump on each of the bonding pads is performed by the wire bonder.

9. The packaging method of claim 6, wherein the conductive bump is made of gold.

10. The packaging method of claim 6, wherein the material of the metal wire is gold.
